(19) United States
(12) Patent Application Publication
(10) Pub. No.: US 2005/0008247 A1
(43) Pub. Date: Jan. 13, 2005

(54) METHOD FOR PROCESSING AN IMAGE USING DIFFERENCE WAVELET

(76) Inventor: Ming-Huang Kuo, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,265

(22) Filed: Jul. 7, 2003

(51) Int. Cl. G06K 9/36

(52) U.S. Cl. 382/260

(57) ABSTRACT

A method of processing an image using a difference wavelet. The method includes loading the image into an image processing program, decomposing the image using a difference wavelet, truncating the image below a predetermined threshold level or enhancing the image according to an enhancement function, reconstructing the image using the difference wavelet, and outputting the image.

### BACKGROUND OF INVENTION

1. Field of the Invention

The present invention relates to image processing, and more specifically, to a method for processing an image using a difference wavelet for smoothing, enhancing, and removing noise from the image.

2. Description of the Prior Art

Wavelets are mathematical functions that divide data into various frequency groups, and then study each group with a resolution according to its scale. Wavelets are particularly well suited for analyzing physical situations where a signal contains discontinuities and sharp spikes. Because of these properties, wavelets are now commonly used in image processing applications. Three main wavelet categories are Cohen-Daubechies-Feauveau (CDF) wavelets, Chui-Wang wavelets, and difference wavelets. Difference wavelets are thoroughly described in the paper “An Introduction to Wavelets” by I-Liang Chern, Department of Mathematics, National Taiwan University, 1998, which is incorporated herein by reference.

In the past, CDF wavelets and Chui-Wang wavelets have been used in image processing for operations such as enhancing the image, smoothing the image, and removing noise from the image. However both of these types of wavelets require a large amount of computation for processing images.

### SUMMARY OF INVENTION

It is therefore a primary objective of the claimed invention to provide a method of processing an image using a difference wavelet in order to solve the above-mentioned problems.

According to the claimed invention, a method of processing an image using a difference wavelet is disclosed. The method includes loading the image into an image processing program, decomposing the image using a difference wavelet, truncating the image below a predetermined threshold level or enhancing the image according to an enhancement function, reconstructing the image using the difference wavelet, and outputting the image.

It is an advantage of the claimed invention that using a difference wavelet for image processing provides a better ability to smoothen images, enhance images, and remove noise from images than the prior art method while requiring a small amount of computation. Therefore, the difference wavelet can process images faster than other wavelets used for image processing according to the prior art.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a flowchart specifying a broad overview of the present invention method of processing an image with a difference wavelet.

FIG. 2 is a flowchart specifying a detailed description of the present invention method of processing an image with a difference wavelet.

### DETAILED DESCRIPTION

The present invention makes use of a difference wavelet to process images. Difference wavelets provide an excellent ability to enhance sharpness and smoothen images as compared to other wavelets. This is especially true if parameters for the difference wavelet are carefully chosen to provide optimum results. Moreover, using the difference wavelet only requires a small amount of computation and is faster than other comparable wavelets.

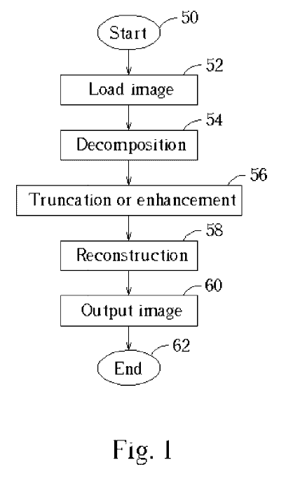

Please refer to FIG. 1. FIG. 1 is a flowchart specifying a broad overview of the present invention method of processing an image with a difference wavelet.
Step 50: Start;
Step 52: Load the image to be processed into an image processing program;
Step 54: Perform a decomposition process on the image using the difference wavelet;
Step 56: Perform a truncation process or an enhancement process on the image for smoothing the image, enhancing the image, or removing noise from the image;
Step 58: Perform a reconstruction process on the image using the difference wavelet;
Step 60: Output the image to a file; and
Step 62: End.

The decomposition process shown in step 54 and the reconstruction process shown in step 58 are exact inverses of each other. Therefore, if no truncation or enhancement is performed in step 56, the image produced as a result of the method shown in FIG. 1 will be identical to the original image.

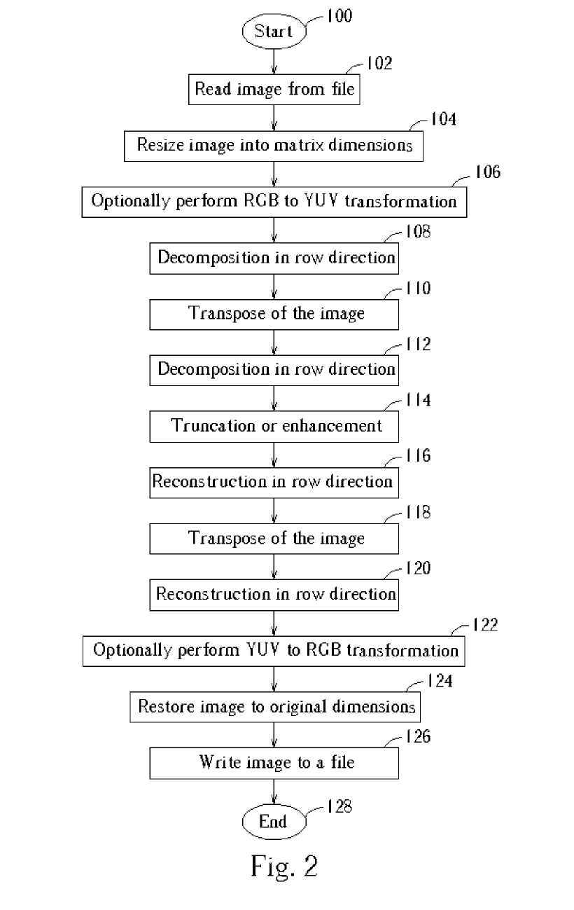

Please refer to FIG. 2. FIG. 2 is a flowchart specifying a detailed description of the present invention method of processing an image with a difference wavelet.
Step 100: Start;
Step 102: Read image from an input file into the image processing program;
Step 104: Resize the image into a matrix having dimensions of (2^{k}·m×2^{k}·n), wherein m and n are positive integers and k represents a level of the decomposition and reconstruction processes;
Step 106: Optionally perform an RGB (red-green-blue) to YUV (luminance-bandwidth-chrominance) transformation;
Step 108: Perform decomposition of the image row by row;
Step 110: Perform a matrix transpose of the image;
Step 112: Perform another decomposition of the image row by row;
Step 114: Truncate the image below a certain threshold value or enhance the image according to a linear or non-linear curve for smoothening the image or enhancing the sharpness of the image;
Step 116: Perform reconstruction of the image row by row;
Step 118: Perform another matrix transpose of the image;
Step 120: Perform another reconstruction of the image row by row;
Step 122: Optionally perform a YUV to RGB transformation;
Step 124: Restore the image from the matrix dimensions to the original dimensions;
Step 126: Write the image to an output file; and
Step 128: End.

As mentioned above, steps 106 and 122 involve RGB to YUV and YUV to RGB transformations, respectively. These two steps are optionally performed in the present invention due to a significant time cost involved. Images may look smoother if the YUV to RGB transformations are used, however, it takes about as much time to perform the YUV to RGB transformations on a 1 megabyte image as it does for the coding and decoding the image, so computation time is sacrificed.

When truncating the image data in step 114, the truncation can be performed line by line or with the whole image at once. The present invention preferably truncates image data line by line because it is simpler and faster than truncating for the whole image at one time.

As noted above, the present invention decomposition and reconstruction processes both make use of a difference wavelet unlike the prior art methods that use other wavelets. The difference wavelet used for decomposition and reconstruction has a filter bank corresponding to average values and a filter bank corresponding to fluctuation values. Parameters corresponding to these filter banks are labeled as (r, rt), where r represents an average parameter and rt represents a fluctuation parameter. Preferably, parameters (r, rt)=(1, 3) since it has been found that optimum performance and accuracy can be obtained when using these parameter values. During the reconstruction process, a periodic boundary condition is preferably used.

Compared to the prior art method of processing images using CDF wavelets and Chui-Wang wavelets for image processing, the present invention uses difference wavelets in the decomposition and reconstruction processes to provide higher performance with reduced complexity. The present invention method is better able to enhance images, smoothen images, and remove noise from the images than the prior art methods. At the same time, the present invention method requires a smaller amount of computation and is also faster to execute than comparable prior art methods.

Those skilled in the art will readily observe that numerous modifications and alterations of the device may be made while retaining the teachings of the invention. Accordingly, the above disclosure should be construed as limited only by the metes and bounds of the appended claims.

1. A method of processing an image using a difference wavelet, the method comprising:
loading the image into an image processing program;
decomposing the image using the difference wavelet;
truncating the image below a predetermined threshold level or enhancing the image according to an enhancement function;
reconstructing the image using the difference wavelet; and
outputting the image.

2. The method of claim 1 wherein loading the image into an image processing program comprises the step of resizing an original dimension of the image.

3. The method of claim 2 whereinresizing the original dimension of the image comprises resizing the image to have a new dimension of a (2^{k}·m×2^{k}·n) matrix, wherein m and n are positive integers and k represents a level of decomposition and reconstruction.

4. The method of claim 3 wherein decomposing the image using the difference wavelet comprises performing a decomposition process of each row of the image, performing a matrix transpose operation on the image, and performing another decomposition process of each row of the image.

5. The method of claim 3 wherein reconstructing the image using the difference wavelet comprises performing a reconstruction process of each row of the image, performing a matrix transpose operation on the image, and performing another reconstruction process of each row of the image.

6. The method of claim 3 wherein outputting the image comprises resizing the image back to its original dimension.

7. The method of claim 1 wherein after decomposing the image using the difference wavelet the method further comprises performing an RGB (red-green-blue) to YUV (luminance-bandwidth-chrominance) transformation.

8. The method of claim 7 wherein after reconstructing the image using the difference wavelet the method further comprises performing a YUV to RGB transformation.

9. The method of claim 1 wherein the truncation process is performed line by line on the image.

10. The method of claim 1 wherein the difference wavelet used for decomposition and reconstruction has a filter bank corresponding to average values and a filter bank corresponding to fluctuation values.

11. The method of claim 10 wherein parameters of the difference wavelet used for decomposition and reconstruction are (r, rt)=(1, 3), where r represents an average parameter and rt represents a fluctuation parameter.

12. The method of claim 1 wherein the reconstruction process is performed by using periodic boundary conditions.

13. The method of claim 1 wherein both truncating the image below the predetermined threshold level and enhancing the image according to the enhancement function are performed after decomposing the image using the difference wavelet.
